(19) United States
(12) Patent Application Publication
(10) Pub. No.: US 2023/0135886 A1
(43) Pub. Date: May 4, 2023

(54) PROCESS OF POST-WASH REMOVING MICROORGANISM FROM GARMENTS

(71) Applicant: The Procter & Gamble Company, Cincinnati, OH (US)

(72) Inventors: FEI LI, BEIJING (CN); YUXIANG LIU, BEIJING (CN)

(21) Appl. No.: 17/517,707

(22) Filed: Nov. 3, 2021

(51) Int. Cl. C11D 3/48; C11D 11/00; C11D 1/83; C11D 3/24; C11D 3/37; D06L 1/16

(52) U.S. Cl. CPC C11D 3/48; C11D 11/0017; C11D 1/83; C11D 3/24; C11D 3/3723; D06L 1/16; C11D 1/22

(57) ABSTRACT

A process of post-wash removing microorganism from garments is provided in which the process includes a) providing an article of clothing in a washing machine; and b) contacting said article of clothing during a wash sub-cycle of said washing machine with a liquid detergent composition including a surfactant system and an anti-microbial agent comprising a diphenyl ether in which the surfactant system includes a C₆-C₂₀ linear alkylbenzene sulfonate as the main surfactant.

### FIELD OF THE INVENTION

The present invention relates to a process of post-wash removing microorganism from garments comprising the steps of a) providing an article of clothing in a washing machine; and b) contacting said article of clothing during a wash sub-cycle of said washing machine with a liquid detergent composition comprising a surfactant system and an anti-microbial agent selected from the group consisting of diphenyl ethers in which the surfactant system comprises a C₆-C₂₀ linear alkylbenzene sulfonates (LAS) as the main surfactant.

### BACKGROUND OF THE INVENTION

Consumer products have evolved to address user needs for an anti-microbial benefit, in addition to their original intended functions. For example, an anti-microbial laundry detergent product is desired by users as it cleans fabrics whilst having an anti-microbial benefit on fabrics. Currently, various anti-microbial agents, e.g., bleaching agents, Chloroxylenol (PCMX), Benzalkonium Chloride (BKC), diphenyl ethers, are known for use in consumer product formulations to deliver an anti-microbial effect. Anti-microbial agents comprise two main types, in which one type functions as agents for removing microorganisms during the wash (e.g. bleaching agents, PCMX, BKC) and the other type functions as agents for preventing microorganisms during storage or use (e.g., diphenyl ethers).

However, it is still challenging to achieve a desired anti-microbial efficacy. Especially, there is no known anti-microbial detergent products which can deliver a post-wash microbial removal during storage or use of garments. Particularly, for those anti-microbial agents that functions as agents for removing microorganisms, they can function only during the wash because they cannot deposit onto garments. On the other hand, diphenyl ethers can function as a preventive means for the growth of microorganisms during the use of garments after they are deposited onto garments through the wash, but not effective in removing microorganisms which are already present on garments. However, it is desirable for consumers to provide anti-microbial detergent products which can deliver benefits of not only post-wash microorganism prevention, but also post-wash microorganism removal.

Thus, there is a continuing need for laundry detergent compositions that can deliver an effective benefit for post-wash removing microorganism from garments.

### SUMMARY OF THE INVENTION

It is a surprising and unexpected discovery of the present invention that the combination of a surfactant system comprising a C₆-C₂₀ linear alkylbenzene sulfonates (LAS) as the main surfactant and an anti-microbial agent selected from the group consisting of diphenyl in a liquid detergent formulation can deliver an effective benefit for post-wash removing microorganism from garments.

Particularly, the present invention provides a liquid detergent composition comprising from 2% to 60% by weight of the composition of a surfactant system and from 0.01% to 1% by weight of the composition of an anti-microbial agent that is a hydroxyl diphenyl ether of formula (I):

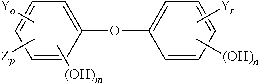

wherein:
each Y is independently selected from chlorine, bromine, or fluorine,
each Z is independently selected from SO₂H, NO₂, or C₁-C₄ alkyl,
r is 0, 1, 2, or 3,
is 0, 1, 2, or 3,
p is 0, 1, or 2,
m is 1 or 2, and
n is 0 or 1

wherein the surfactant system comprises C₆-C₂₀ linear alkylbenzene sulfonates (LAS) as the main surfactant.

Correspondingly, the present invention in one aspect relates to a process of post-wash removing microorganism from an article of clothing comprising the steps of:
a) providing an article of clothing in a washing machine; and
b) contacting said article of clothing during a wash sub-cycle of said washing machine with the liquid detergent composition according to the present disclosure.

In another aspect, the present invention relates to use of the liquid detergent composition according to the present disclosure for removing microorganism from an article of clothing after the wash.

Preferably, the composition comprises from 4% to 50%, preferably from 6% to 40%, more preferably from 10% to 30%, by weight of the composition of the surfactant system.

Preferably, the surfactant system comprises an additional anionic surfactant selected from the group consisting of C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), and any combinations thereof, and/or a nonionic surfactant selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, and any combinations thereof.

Preferably, the C₆-C₂₀ linear alkylbenzene sulfonates (LAS) is present as the majority surfactant in the composition.

Preferably, the surfactant system comprises:
1) from 50.1% to 90%, preferably from 51% to 70%, more preferably from 52% to 60%, for example 52%, 53%, 54%, 55%, 56%, 57%, 58%, 59%, 60%, 65% or any ranges therebetween, by weight of the surfactant system of C₆-C₂₀ linear alkylbenzene sulfonates (LAS),
2) from 10% to 49.9%, preferably from 30% to 49%, more preferably from 40% to 45%, for example 35%, 40%, 41%, 42%, 43%, 44%, 45%, 46%, 47%, 48% or any ranges therebetween, by weight of the surfactant system of C₆-C₂₀ alkyl alkoxy sulfates (AAS), and
3) from 0.5% to 10%, preferably from 1% to 8%, more preferably from 2% to 6%, for example 1%, 2%, 3%, 4%, 5%, 6%, 7%, 8%, 9%, 10%, or any ranges therebetween, by weight of the surfactant system of C₁₀-C₁₈ alkyl ethoxylate.

Preferably, the composition comprises from 0.01% to 0.1%, preferably from 0.01% to 0.05%, more preferably from 0.01% to 0.04%, most preferably from 0.02% to 0.03%, by weight of the composition of said anti-microbial agent that is preferably selected from the group consisting of 4-4′-dichloro-2-hydroxy diphenyl ether, 2,4,4′-trichloro-2′-hydroxy diphenyl ether, and a combination thereof, and wherein more preferably said anti-microbial agent is 4-4′-dichloro-2-hydroxy diphenyl ether.

Preferably, the composition further comprises from 0.1% to 10%, preferably from 0.2% to 5%, more preferably from 0.3% to 2%, by weight of the composition of a polyamine, preferably a polyethyleneimine, more preferably an alkoxylated polyethyleneimine.

In some preferred embodiments, the composition comprises:
a) from 15% to 30% by weight of the composition of the surfactant system comprising from 52% to 60%, by weight of the surfactant system of C₆-C₂₀ linear alkylbenzene sulfonates (LAS), from 40% to 45%, by weight of the surfactant system of C₆-C₂₀ alkyl alkoxy sulfates (AAS), and from 2% to 6%, by weight of the surfactant system of C₁₀-C₁₈ alkyl ethoxylate;
b) from 0.01% to 0.04% by weight of the composition, of 4-4′-dichloro-2-hydroxy diphenyl ether; and
c) from 0.3% to 2% by weight of the composition of an alkoxylated polyethyleneimine.

In another aspect, the present invention relates to a liquid detergent composition as mentioned hereinabove for the use of post-wash removing microorganisms from garments.

It is an advantage of the liquid detergent composition according to the present disclosure that it may improve the microbial removal. Particularly, the liquid detergent composition according to the present disclosure may significantly reduce the amount of microorganism from fabrics during the use and/or storage after the wash. In the context of the present disclosure, removing microorganism is intended to mean reducing the amount of viable microorganism, including but not limited to kill, deactivate, and/or eliminate microorganism. Particularly, post-wash removing microorganism is intended to mean reducing the amount of viable microorganism during the use and/or storage of garments after the wash.

### DETAILED DESCRIPTION OF THE INVENTION

### Definitions

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the term “laundry detergent composition” means a composition for cleaning soiled materials, including fabrics. Such compositions may be used as a pre-laundering treatment, a post-laundering treatment, or may be added during the rinse or wash cycle of the laundering operation. The laundry detergent composition compositions may have a form selected from liquid, powder, single-phase or multi-phase unit dose, pouch, tablet, gel, paste, bar, or flake. Preferably, the laundry detergent composition is a liquid. The term “liquid laundry detergent composition” herein refers to compositions that are in a form selected from the group consisting of pourable liquid, gel, cream, and combinations thereof. The liquid laundry detergent composition may be either aqueous or non-aqueous, and may be anisotropic, isotropic, or combinations thereof.

As used herein, the term “anti-microbial agent” refers to a chemical compound of which the principle intended function is to kill bacteria and/or to prevent their growth or reproduction. Traditional anti-microbial agents include cationic anti-microbial agents (e.g., certain ammonium chlorides), nonionic anti-microbial agents, etc. diphenyl ether compounds that are used in the present invention are nonionic anti-microbial agents.

As used herein, the term “main surfactant” refers to a surfactant that is present in a composition at an amount that is greater than any other surfactant contained by such composition.

As used herein, the term “majority surfactant” refers to a surfactant that is present in a composition at an amount that is at least 50% by weight of the total surfactant content in such composition.

As used herein, the term “alkyl” means a hydrocarbyl moiety which is branched or unbranched, substituted or unsubstituted. Included in the term “alkyl” is the alkyl portion of acyl groups.

As used herein, the term “washing solution” refers to the typical amount of aqueous solution used for one cycle of laundry washing, preferably from 1 L to 50 L, alternatively from 1 L to 20 L for hand washing and from 20 L to 50 L for machine washing.

As used herein, the term “soiled fabric” is used non-specifically and may refer to any type of natural or artificial fibers, including natural, artificial, and synthetic fibers, such as, but not limited to, cotton, linen, wool, polyester, nylon, silk, acrylic, and the like, as well as various blends and combinations.

### Liquid Detergent Composition

The liquid detergent composition of the present invention comprises from 2% to 60% by weight of the composition of a surfactant system and from 0.01% to 1% by weight of the composition of an anti-microbial agent that is a hydroxyl diphenyl ether of formula (I):

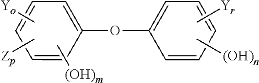

wherein:
each Y is independently selected from chlorine, bromine, or fluorine,
each Z is independently selected from SO₂H, NO₂, or C₁-C₄ alkyl,
r is 0, 1, 2, or 3,
is 0, 1, 2, or 3,
p is 0, 1, or 2,
m is 1 or 2, and
n is 0 or 1

wherein the surfactant system comprising C₆-C₂₀ linear alkylbenzene sulfonates (LAS) as the main surfactant.

It has been surprisingly found that, by combining a surfactant system comprising LAS as the main surfactant and a diphenyl ether, an excellent efficacy of post-wash removing microorganisms can be achieved. Such effect is unexpected because no such efficacy was identified in liquid detergent composition previously.

Preferably, the composition comprises from 4% to 50%, preferably from 6% to 40%, more preferably from 10% to 30%, by weight of the composition of the surfactant system.

Preferably, the surfactant system comprises an additional anionic surfactant selected from the group consisting of C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), and any combinations thereof, and/or a nonionic surfactant selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, and any combinations thereof.

Preferably, the C₆-C₂₀ linear alkylbenzene sulfonates (LAS) is present as the majority surfactant in the composition.

The laundry detergent composition herein provides efficacy for removing Gram positive bacteria (e.g., Staphylococcus aureus). In one embodiment, the laundry detergent composition provides a Microbial Removal Value of at least a log 1.0 reduction, preferably a log 1.5 reduction, more preferably a log 2.0 reduction, even more preferably a log 2.5 reduction, most preferably a log 3.0 reduction, against Gram positive bacteria at 18-hour after inoculation compared to the time of inoculation. Preferably, the composition provides at least a log 2.2 reduction, preferably a log 2.5 reduction, against Staphylococcus aureus at 18-hour after inoculation as determined by the Test 1 as described below. More preferably, the composition provides at least a log 3.0 reduction against Staphylococcus aureus. It is worth noting that Staphylococcus aureus is frequently found on human skin and therefore fabrics (particularly wearing fabrics) are in particular need of anti-microbial effects against Staphylococcus aureus.

The laundry detergent composition can have any suitable viscosity depending on factors such as formulated ingredients and purpose of the composition. In one embodiment, the composition has a high shear viscosity value, at a shear rate of 20/sec and a temperature of 21° C., of about 200 to about 3,000 cP, alternatively about 300 to about 2,000 cP, alternatively about 500 to about 1,000 cP, and a low shear viscosity value, at a shear rate of 1/sec and a temperature of 21° C., of about 500 to about 100,000 cP, alternatively about 1000 to about 10,000 cP, alternatively about 1,500 to about 5,000 cP.

### Surfactant System

Preferably, the composition comprises from 4% to 50%, preferably from 6% to 40%, more preferably from 10% to 30%, by weight of the composition of the surfactant system. Particularly, the surfactant system may comprise an additional anionic surfactant and a nonionic surfactant in addition to LAS.

The anionic surfactant suitable for the composition in the present invention may be selected from the group consisting of C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), and any combinations thereof. For example, the laundry detergent composition may contain a C₆-C₂₀ alkyl alkoxy sulfates (AAₓS), wherein x is about 1-30, preferably about 1-15, more preferably about 1-10, most preferably x is about 1-3. The alkyl chain in such AAₓS can be either linear or branched, with mid-chain branched AAₓS surfactants being particularly preferred. A preferred group of AAₓS include C₁₂-C₁₄ alkyl alkoxy sulfates with x of about 1-3.

The nonionic surfactant suitable for the composition in the present invention may be selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, and any combinations thereof. Non-limiting examples of nonionic surfactants suitable for use herein include: C₁₂-C₁₈ alkyl ethoxylates, such as Neodol® nonionic surfactants available from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as Pluronic® available from BASF; C₁₄-C₂₂ mid-chain branched alkyl alkoxylates, BAEx, wherein x is from about 1 to about 30; alkylpolysaccharides, specifically alkylpolyglycosides; polyhydroxy fatty acid amides; and ether capped poly(oxyalkylated) alcohol surfactants. Also useful herein as nonionic surfactants are alkoxylated ester surfactants such as those having the formula R¹C(O)O(R₂O)nR³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between about 1 and about 20. Such alkoxylated ester surfactants include the fatty methyl ester ethoxylates (MEE) and are well-known in the art. In some particular embodiments, the alkoxylated nonionic surfactant contained by the laundry detergent composition of the present invention is a C₆-C₂₀ alkoxylated alcohol, preferably C₈-C₁₈ alkoxylated alcohol, more preferably C₁₀-C₁₆ alkoxylated alcohol. The C₆-C₂₀ alkoxylated alcohol is preferably an alkyl alkoxylated alcohol with an average degree of alkoxylation of from about 1 to about 50, preferably from about 3 to about 30, more preferably from about 5 to about 20, even more preferably from about 5 to about 9.

In some embodiments, the composition comprises a C₆-C₂₀ linear alkylbenzene sulfonate surfactant (LAS), preferably C₁₀-C₁₆ LAS, and more preferably C₁₂-C₁₄ LAS.

Preferably, the C₆-C₂₀ linear alkylbenzene sulfonates (LAS) is present as the majority surfactant in the composition.

Preferably, the surfactant system comprises:
1) from 50.1% to 90%, preferably from 51% to 70%, more preferably from 52% to 60%, by weight of the surfactant system of C₆-C₂₀ linear alkylbenzene sulfonates (LAS),
2) from 10% to 49.9%, preferably from 30% to 49%, more preferably from 40% to 45%, by weight of the surfactant system of C₆-C₂₀ alkyl alkoxy sulfates (AAS), and
3) from 0.5% to 10%, preferably from 1% to 8%, more preferably from 2% to 6%, by weight of the surfactant system of C₁₀-C₁₈ alkyl ethoxylate.

The laundry detergent composition of the present invention may further comprise a cationic surfactant. Non-limiting examples of cationic surfactants include: quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; and amino surfactants, specifically amido propyldimethyl amine (APA).

### Diphenyl Ether-Based Anti-microbial Agent

The diphenyl ether-based anti-microbial agent of the present invention is a nonionic compound. In the present invention, it has been found that due to its nonionic property, the anti-microbial agent of the present invention allows for a stable liquid detergent composition.

Preferably, the anti-microbial agent is a hydroxyl diphenyl ether. The anti-microbial agent herein can be either halogenated or non-halogenated, but preferably is halogenated. In one embodiment, the anti-microbial agent is a hydroxyl diphenyl ether of formula (I):

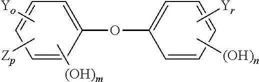

wherein:
each Y is independently selected from chlorine, bromine, or fluorine, preferably is chlorine or bromine, more preferably is chlorine,
each Z is independently selected from SO₂H, NO₂, or C₁-C₄ alkyl,
r is 0, 1, 2, or 3, preferably is 1 or 2,
o is 0, 1, 2, or 3, preferably is 0, 1 or 2,
p is 0, 1, or 2, preferably is 0,
m is 1 or 2, preferably is 1, and
n is 0 or 1, preferably is 0.

In the above definition for formula (I), 0 means nil. For example, when p is 0, then there is no Z in formula (I). Each Y and each Z could be the same or different. In one embodiment, o is 1, r is 2, and Y is chlorine or bromine. This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

More Preferably, the anti-microbial agent is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan® HP100.

In addition to the diphenyl ether, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

### Polyamine

The laundry detergent composition herein may further comprise from 0.1% to 10%, preferably from 0.2% to 5%, more preferably from 0.3% to 2%, by weight of the composition of a polyamine, preferably a polyethyleneimine, more preferably an alkoxylated polyethyleneimine.

The polyamine suitable for the laundry detergent composition herein may be of Mw higher than 400 g/mol. A preferred class of polyamines is polyethyleneimines (PEIs) and derivatives thereof such as ethoxylated PEI polymers, propoxylated PEI polymers, polyamines, polyquats, polyglycerol quats, and other PEI derivatives, their salts or mixtures thereof. In some preferred embodiments, the PEIs are branched, spherical polymeric amines, and the molecular weight of the PEI or PEI salt used is from about 800 daltons to about 2 million Daltons. In addition, in some preferred embodiments, the charge density of the PEI or PEI salt used is from about 15 meq/g to about 25 meq/g, more preferably from about 16 meq/g to about 20 meq/g. Examples of such preferred PEIs include the BASF products LUPASOL WF (25 kDa; 16-20 meq/g) and Lupasol® FG (800 daltons; 16-20 meq/g), and the SOKALAN® family of polymers available from BASF, e.g., SOKALAN® HP20, and SOKALAN® HP22 G.

### Adjunct Ingredients

The laundry detergent composition herein may comprise adjunct ingredients. Suitable adjunct materials include but are not limited to: builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, perfume microcapsules, structure elasticizing agents, fabric softeners, carriers, hydrotropes, processing aids, solvents, hueing agents, structurants and/or pigments. The precise nature of these adjunct ingredients and the levels thereof in the laundry detergent composition will depend on the physical form of the composition and the nature of the cleaning operation for which it is to be used.

In one embodiment, the composition herein comprises a rheology modifier (also referred to as a “structurant” in certain situations), which functions to adjust the viscosity of the composition so as to be more applicable to the packaging assembly. The rheology modifier herein can be any known ingredient that is capable of suspending particles and/or adjusting rheology to a liquid composition. Preferably the rheology modifier is selected from the group consisting of hydroxy-containing crystalline material, polyacrylate, polysaccharide, polycarboxylate, alkali metal salt, alkaline earth metal salt, ammonium salt, alkanolammonium salt, C₁₂-C₂₀ fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof. Preferably, the rheology modifier is a hydroxy-containing crystalline material generally characterized as crystalline, hydroxyl-containing fatty acids, fatty esters and fatty waxes, such as castor oil and castor oil derivatives. More preferably the rheology modifier is a hydrogenated castor oil (HCO).

### Composition Preparation

The laundry detergent composition of the present invention is generally prepared by conventional methods such as those known in the art of making laundry detergent compositions. Such methods typically involve mixing the essential and optional ingredients in any desired order to a relatively uniform state, with or without heating, cooling, application of vacuum, and the like, thereby providing laundry detergent compositions containing ingredients in the requisite concentrations.

### Method of Use

Another aspect of the present invention is directed to a method of using the laundry detergent composition to treat a fabric with a microbial removal benefit and optionally a microbial preventive benefit. The method comprises the step of administering from 5 g to 120 g of the above-mentioned laundry detergent composition into a laundry washing basin comprising water to form a washing solution. The washing solution in a laundry washing basin herein preferably has a volume from 1 L to 50 L, alternatively from 1 L to 20 L for hand washing and from 20 L to 50 L for machine washing. Preferably, the post-wash microbial removal benefit herein is determined by the method as described in Test 1 (i.e. GB/T 20944.2-2007 Adsorption method). The temperatures of the laundry washing solution preferably range from 5° C. to 60° C. The dosing amount in the method herein may be different depending on the washing type.

In one embodiment, the method comprises administering from about 5 g to about 60 g of the laundry detergent composition into a hand washing basin (e.g., about 2-4 L). In an alternative embodiment, the method comprises administering from about 5 g to about 100 g, preferably from about 10 g to about 65 g of the laundry detergent composition into a washing machine (e.g., about 30-45 L).

Preferably, the method herein further comprises the step of contacting a soiled fabric with the washing solution. For example, the presence of Gram-positive bacteria and/or Gram-negative bacteria is suspected on the fabric. The step of contacting the soiled fabric with the washing solution is preferably after the step of administering the laundry detergent composition in a laundry washing basin. The method may further comprise the step of contacting a fabric with the laundry detergent composition prior to the step of administering the laundry detergent composition in a laundry washing basin, i.e., pre-treat the fabric with the laundry detergent composition for certain time, preferably from 1 minute to 10 minutes.

### Test Method

### Test 1: Efficacy of Post-Wash Microbial Removal (GB/T 20944.2-2007 Adsorption Method)

The efficacy of post-wash microbial removal for laundry detergent compositions is determined by the method as defined in the GB/T 20944.2-2007 Adsorption method and described hereinafter.
1. Microorganism Preparation:
   A. Aseptically add certain amount of nutrient broth into a lyophilized culture of Staphylococcus aureus, Escherichia coli or Klebsiella pneumoniae. Dissolve and suspend the culture in the nutrient broth to obtain a suspension. Streak a loop of the suspension onto a nutrient agar plate, and incubate at 37° C. for 24 hours to obtain a first generation subculture of bacterial suspension. Transfer a loop of the first generation subculture of bacterial suspension into 20 mL of nutrient broth with shaking, and incubate at 37° C. for 24 hours to obtain a second generation subculture of bacterial suspension. Transfer 0.4 mL of the second generation subculture of bacterial suspension into another 20 mL of nutrient broth with shaking, and incubate at 37° C. for 3±1 hours to obtain a third generation subculture of bacterial suspension.
   B. Dilute the third generation subculture of bacterial suspension by 1/20 diluted nutrient broth to 1×10⁵ CFU/mL˜3×10⁵ CFU/mL to obtain a working culture.
   C. Store the working culture at 4° C. The working culture cannot be stored overnight.
2. Fabric washing:
   A. Boil two fabric strips each having a width of 1 m and length of 3 m (32 yarn/cm×32 yarn/cm, 100% plain weave cotton) in 5 L of a solution for 1 hour. The solution is prepared by 2.5 g of a nonionic soaked agent, 2.5 g of sodium carbonate, and 5000 mL of distilled water. The nonionic soaked agent is prepared by 5.0 g of alkylphenol ethoxylate, 5 g of sodium carbonate, and 1000 mL of distilled water. Rinse the fabric strips in boiled deionized water for 5 minutes. Place the fabric strips in cool deionized water for 5 minutes, and indoor dry. One fabric strip serves as a test fabric strip for following steps 2B-2I, and the other fabric strip is used as control (without experiencing steps 2B-2I).
   B. Fix one end of the test fabric strip obtained from step 2A onto a stainless steel spindle at an outer position along the horizontal extension of the stainless steel spindle. The stainless steel spindle has 3 horizontal stands that are connected to one another. Wrap the test fabric strip around the 3 horizontal stands of the stainless steel spindle with sufficient tension to obtain a fabric wrapped spindle having 12 laps of fabric. Fix the other end of the test fabric strip onto the outer lap of the 12 laps of fabric via a pin. Sterilize the fabric wrapped spindle with pressure steam at 121° C. for 15 minutes.
   C. Dissolve 5.903 g of calcium chloride dihydrate and 2.721 g of magnesium chloride hexahydrate in 100 mL of distilled water, and then sterilize the mixture with pressure steam at 121° C. for 20 minutes. Add 1 mL of the mixture into 1 L of distilled water to obtain a hard water solution.
   D. Add sufficient amount of sample into 1 L of the hard water solution obtained from step 2C to obtain a solution having a concentration of 1055 ppm. Mix the solution by a magnetic stirrer for 4 minutes. Distribute 250 mL of the mixed solution into an exposure chamber to obtain a washing solution. Place the exposure chamber in a water bath and achieve the test temperature of (25±1°) C.
   E. Aseptically soak the fabric wrapped spindle obtained from step 2B into the washing solution in the exposure chamber, and close the exposure chamber with a lid.
   F. Fix the exposure chamber onto a tumbler. Rotate the tumbler for 10 minutes. Then remove the fabric wrapped spindle from the exposure chamber. Place the fabric wrapped spindle in Haier iwash-1p Top Load Washing Machine and spin-dry for 2 minutes.
   G. Discard the washing solution from the exposure chamber, and then add 250 mL of sterilized distilled water into the exposure chamber. Soak the spin-dried fabric wrapped spindle in the newly added distilled water in the exposure chamber. Rotate the tumbler for 3 minutes and spin-dry for 2 minutes.
   H. Repeat step 2G.
   I. Aseptically remove the fabric wrapped spindle out of the exposure chamber and remove the test fabric strip from the spindle. Air dry the test fabric strip overnight.
3. Fabric Incubation:
   A. Cut the washed test fabric strip obtained from step 2I to square pieces having a side length of 2 cm. Three (3) sets of 0.4 g of the pieces serve as specimens for the following steps.
   B. Put each set of specimens into a vial, and then sterilize the specimens with pressure steam at 121° C. for 15 minutes. After the sterilization, dry the specimens for 1 hour in a clean bench without a cap.
   C. Inoculate 0.2 mL of the working culture obtained from step 1C onto each dried specimen. Incubate the vials containing the inoculated specimens at 37° C. for 18 hours.
   D. Extract survivors on the incubated specimens, plate with nutrient agar, and incubate at 37° C. for 24-48 hours. Count the total colony-forming units (CFU) of each set of specimens, and obtain average results of the 3 sets. Take the log 10 value of CFU value as Mb.
   E. In steps 3A-3D, use the fabric strip obtained from step 2A (that does not experience steps 2B-2I) as control. Take the log 10 value of CFU value as Ma.
   F. In step 3C, a parallel vial for each inoculated specimen was taken immediately after inoculation for cell concentration determination. Extract survivors on the incubated specimens, plate with nutrient agar, and incubate at 37° C. for 24-48 hours. Count the total colony-forming units (CFU) of each set of specimens, and obtain average results of the 3 sets. Take the log 10 value of CFU value as Mc.
4. Calculation of Bacteriostatic Activity Value and Post-Wash Microbial Removal Activity Value:

Bacteriostatic Activity Value=Ma−Mb

Post-Wash Microbial Removal Activity Value=Mc−Mb

A Bacteriostatic Activity Value of no less than 2.0 represents acceptable microbial preventive efficacy, of no less than 2.5 represents good microbial preventive efficacy, and of no less than 3.0 represents excellent microbial preventive efficacy. And a Bacteriostatic Activity Value of lower than 2.0 indicates unacceptable poor microbial preventive efficacy.

A Bacteriostatic Activity Value of at least 1.0 represents acceptable post-wash microbial removal efficacy, of at least 2.0 represents good post-wash microbial removal efficacy, and of at least 3.0 represents excellent post-wash microbial removal efficacy.

### Test 2: Fabric Deposition Test for Anti-Microbial Agents

Anti-microbial agents are extracted from treated fabrics by using the methanol-based Accelerated Solvent Extraction (ASE) method described hereinafter. The resulting extract is then subjected to gradient reversed-phase high performance liquid chromatographic (HPLC) separation on a C18 column and is quantified by tandem mass spectrometry (MS/MS) operating under multiple reaction monitoring (MRM) conditions at negative mode.

As a first step, about three (3) grams of the treated fabrics is accurately weighed and then filled into a steel ASE tube. The extraction protocol is run for about five (5) minutes using methanol as the extraction solvent at an elevated temperature of about 100° C. and a pressure of about 2000 pound per square inch (psi). The resulting extract is collected and transferred into a 25-ml flask, which is then filled to its full volume with methanol. The resulting solution is then diluted by about twenty-five (25) fold by using a mixture of methanol and water at a 50:50 ratio, which is used as an injection sample for the subsequent LC-MS/MS analysis.

Next, about five (5) ul of the above-mentioned injection sample is injected and separated on a Waters ACQUITY UPLC C18 column with gradient from about 70% mobile phase A (1% formic water solution)/30% mobile phase B (0.1% formic acid in methanol) to 5% mobile phase A/95% mobile phase B in about three (3) minutes, and the final gradient is kept for another three (3) minutes. The anti-microbial agent, for example Tinosan® HP100, is detected at the negative MRM mode. The ion pair of m/z 253>142 is used as quantification transition, while m/z of 253>125 is used for identification.

Subsequently, spiked matrix standards in the range of 0.5 mg/ml to 500 ng/ml are injected for creation of a calibration curve. Concentration of the anti-microbial agent, for example Tinosan® HP100, in the injection sample is determined by extrapolation using weighted (1/x²) quadratic regression of the calibration curve.

### EXAMPLES

### Example 1: Comparative Test Showing Effective Post-Wash Microbial Removal by Liquid Detergent Composition Containing Surfactant System and Diphenyl Ether

Liquid laundry detergent compositions were prepared containing the ingredients as shown in Table 1 below, in which Inventive Sample 1 comprises a surfactant system containing LAS as the main surfactant and a diphenyl ether while Comparative Sample 2 comprise a surfactant system containing NI as the main surfactant and a diphenyl ether.

TABLE 1

| | Inventive | Comparative |
|---|---|---|
| Ingredients (wt %) | Sample 1 | Sample 2 |
| LAS ^{a} | 8.86 | 3.58 |
| Additional anionic surfactant ^{b} | 6.89 | 2.06 |
| Non-ionic surfactant ^{c} | 0.52 | 10.67 |
| Tinosan ®HP100 ^{d} | 0.026 | 0.026 |
| Solvent | 1.05 | 0.58 |
| Caustic | 1.95 | 1.28 |
| Polyethyleneimines ^{e} | 0.09 | 0.45 |
| Fatty acid | 2.73 | 1.14 |
| Citric acid | 0.93 | 1.19 |
| DTPA | 0.18 | 0.03 |
| Perfume | 0.55 | 0.5 |

^{a} C₁₁₋₁₃LAS
^{b} C₁₂₋₁₄AE₁₋₃S, available from Shell
^{c} Neodol ®25-7 which is C₁₂-C₁₅ alcohol ethoxylated with an average of 7 moles of ethylene oxide as a nonionic surfactant, available from Shell
^{d} Tinosan ®HP100 is 4-4’-dichloro-2-hydroxy diphenyl ether, available from BASF
^{e} Polyethyleneimines (PEI) polymer ethoxylated or ethoxylated and propoxylated, available from BASF

Then, the efficacy of post-wash microbial removal for the above samples at a dose of 1000 ppm finished product was determined in accordance with Test 1: Efficacy of Post-Wash Microbial Removal in which Staphylococcus aureus, ATCC 6538 was used. The results are shown below.

TABLE 2

| | | Cell | Cell | | |
|---|---|---|---|---|---|
| | | Concentration | Concentration | | Post-Wash |
| | Cell | for standard | for anti-bacterial | | Microorganism |
| | Concentration | blank samples | fabric samples | Bacteriostatic | Removal |
| | at 0 h | at 18 h | at 18 h | Value (log | Value (log |
| | (cfu/Piece) | (cfu/Piece) | (cfu/Piece) | reduction) | reduction) |
| Inventive | 5.1 × 10⁴ | 1.8 × 10⁷ | 2 × 10¹ | 6.0 | 3.4 |
| Sample 1 | | | | | |
| Comparative | 2.7 × 10⁴ | 5.5 × 10⁷ | 5.5 × 10⁴ | 3.0 | −0.3 |
| Sample 2 | | | | | |

As the data shown above, it is surprising and completely unexpected that the combination of the surfactant system comprising LAS as the main surfactant and the diphenyl ether can deliver a very strong post-wash microbial removal efficacy (i.e., more than log 3 reduction). In other words, the Inventive Sample 1 can remove more than 99.9% microorganisms in the microbial removal test. On the contrary, the combination of a different surfactant system combined with the diphenyl ether (Comparative Sample 2) does not show any significant efficacy of post-wash microbial removal (i.e. even less than log 0 reduction).

### Example 2: Exemplary Formulations of Liquid Laundry Detergent Compositions

The following liquid laundry detergent compositions shown in Table 3 are made comprising the listed ingredients in the listed proportions (weight %).

TABLE 3

| | A | B | C | D | E | F | G |
|---|---|---|---|---|---|---|---|
| C₁₂₋₁₄AE₁₋₃S | 8.3 | 6.6 | 7 | 5 | 6 | 3.7 | 14 |
| C₁₁₋₁₃LAS | 10.6 | 9.0 | 8.9 | 10.8 | 21 | 24 | 28 |
| Neodol ®25-7 | — | 0.5 | — | — | 0.5 | 0.6 | 3 |
| Citric acid | 1.2 | 0.9 | 1.0 | 1.1 | 2 | 2 | 4 |
| C₁₂-C₁₈ fatty acid | 2.5 | 2.6 | 2.0 | 3.0 | 2 | 2 | 4 |
| Na-DTPA | 0.2 | — | — | 0.1 | — | 0.9 | 2 |
| GLDA | — | 0.4 | 0.6 | — | 1.5 | — | — |
| p-diol | — | 1 | — | — | 3 | 10 | 18 |
| Silicone emulsion | 0.0025 | 0.0023 | 0.0024 | 0.0024 | — | — | — |
| Monoethanolamine | 0.1 | 0.1 | — | — | — | — | — |
| (MEA) | | | | | | | |
| Hydrogenated castor | 0.12 | 0.12 | — | — | — | — | — |
| oil with MEA | | | | | | | |
| Polyethyleneimines | 0.1 | 0.08 | — | — | 0.5 | — | 1.5 |
| NaOH | Up to | Up to | Up to | Up to | Up to | Up to | Up to |
| | pH 8 | pH 8 | pH 8 | pH 8 | pH 8 | pH 8 | pH 8 |
| Tinosan ®HP100 | 0.03 | 0.027 | 0.05 | 0.029 | 0.05 | 0.06 | 0.08 |
| Brightener | — | 0.09 | — | — | 0.06 | 0.03 | 0.1 |
| Dye | 0.006 | 0.004 | 0.003 | 0.0026 | 0.006 | 0.006 | 0.008 |
| Perfume oil | 0.5 | 0.6 | 0.45 | 0.55 | 0.6 | 0.7 | 1.5 |
| Water | Balance | Balance | Balance | Balance | Balance | Balance | Balance |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of post-wash removing microorganism from an article of clothing comprising:
a) providing an article of clothing in a washing machine; and
b) contacting said article of clothing during a wash sub-cycle of said washing machine with a liquid detergent composition comprising from about 2% to about 60% by weight of the composition of a surfactant system and from about 0.01% to about 1% by weight of the composition of an anti-microbial agent that is a hydroxyl diphenyl ether of formula (I): 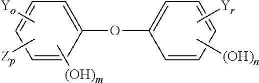
wherein:
each Y is independently selected from chlorine, bromine, or fluorine,
each Z is independently selected from SO₂H, NO₂, or C₁-C₄ alkyl,
r is 0, 1, 2, or 3,
o is 0, 1, 2, or 3,
p is 0, 1, or 2,
m is 1 or 2, and
n is 0 or 1
wherein the surfactant system comprises a C₆-C₂₀ linear alkylbenzene sulfonate as the main surfactant.

2. The process according to claim 1, wherein the composition comprises from about 4% to about 50%, by weight of the composition of the surfactant system.

3. The process according to claim 1, wherein the composition comprises from about 6% to about 40%, by weight of the composition of the surfactant system.

4. The process according to claim 1, wherein the composition comprises from about 10% to about 30%, by weight of the composition of the surfactant system.

5. The process according to claim 1, wherein the surfactant system further comprises an anionic surfactant comprising a C₆-C₂₀ alkyl sulfate, a C₆-C₂₀ alkyl alkoxy sulfate, a C₆-C₂₀ methyl ester sulfonate, a C₆-C₂₀ alkyl ether carboxylate, or a combination thereof.

6. The process of claim 1, wherein the surfactant system further comprises a nonionic surfactant comprising an alkyl alkoxylated alcohol, an alkyl alkoxylated phenol, an alkyl polysaccharide, a polyhydroxy fatty acid amide, an alkoxylated fatty acid ester, a sucrose ester, a sorbitan ester, an alkoxylated sorbitan ester, or a combination thereof.

7. The process according to claim 1, wherein the C₆-C₂₀ linear alkylbenzene sulfonate is present as the majority surfactant in the composition.

8. The process according to claim 1, wherein the surfactant system comprises:
1) from about 50.1% to about 90%, by weight of the surfactant system of the C₆-C₂₀ linear alkylbenzene sulfonate,
2) from about 10% to about 49.9%, by weight of the surfactant system of a C₆-C₂₀ alkyl alkoxy sulfate, and
3) from about 0.5% to about 10%, by weight of the surfactant system of a C₁₀-C₁₈ alkyl ethoxylate.

9. The process according to claim 1, wherein the surfactant system comprises:
1) from about 51% to about 70%, by weight of the surfactant system of the C₆-C₂₀ linear alkylbenzene sulfonate,
2) from about 30% to about 49%, by weight of the surfactant system of a C₆-C₂₀ alkyl alkoxy sulfate, and
3) from about 1% to about 8%, by weight of the surfactant system of a C₁₀-C₁₈ alkyl ethoxylate.

10. The process according to claim 1, wherein the surfactant system comprises:
1) from about 52% to about 60%, by weight of the surfactant system of the C₆-C₂₀ linear alkylbenzene sulfonate,
2) from about 40% to about 45%, by weight of the surfactant system of a C₆-C₂₀ alkyl alkoxy sulfate, and
3) from about 2% to about 6%, by weight of the surfactant system of a C₁₀-C₁₈ alkyl ethoxylate.

11. The process according to claim 1, wherein the composition comprises from 0.01% to 0.1%, preferably from about 0.01% to about 0.05%, by weight of the composition of said anti-microbial agent.

12. The process according to claim 1, wherein the composition comprises from 0.01% to 0.1%, preferably from about 0.01% to about 0.04%, by weight of the composition of said anti-microbial agent.

13. The process according to claim 1, wherein the composition comprises from 0.01% to 0.1%, preferably from about 0.02% to about 0.03%, by weight of the composition of said anti-microbial agent.

14. The process according to claim 1, wherein the antimicrobial agent comprises 4-4′-dichloro-2-hydroxy diphenyl ether, 2,4,4′-trichloro-2′-hydroxy diphenyl ether, or a combination thereof, and

15. The process according to claim 1, wherein said anti-microbial agent comprises 4-4′-dichloro-2-hydroxy diphenyl ether.

16. The process according to claim 1, wherein the composition further comprises from about 0.1% to about 10%, by weight of the composition of a polyamine, wherein the polyamine comprises an an alkoxylated polyethyleneimine.

17. The process according to claim 1, wherein the composition further comprises from about 0.2% to about 5%, by weight of the composition of a polyamine, wherein the polyamine comprises an an alkoxylated polyethyleneimine.

18. The process according to claim 1, wherein the composition further comprises from about 0.3% to about 2%, by weight of the composition of a polyamine, wherein the polyamine comprises an

19. The process according to claim 1, wherein the composition comprises:
a) from about 15% to about 30% by weight of the composition of the surfactant system wherein the surfactant system comprises from about 52% to about 60%, by weight of the surfactant system of the C₆-C₂₀ linear alkylbenzene sulfonate, from about 40% to about 45%, by weight of the surfactant system of a C₆-C₂₀ alkyl alkoxy sulfate, and from about 2% to about 6%, by weight of the surfactant system of a C₁₀-C₁₈ alkyl ethoxylate;
b) from about 0.01% to about 0.04% by weight of the composition, of the antimicrobial agent which comprises a 4-4′-dichloro-2-hydroxy diphenyl ether; and
c) from about 0.3% to about 2% by weight of the composition of an alkoxylated polyethyleneimine.
